(19) United States
(12) Patent Application Publication
(10) Pub. No.: US 2008/0278829 A1
(43) Pub. Date: Nov. 13, 2008

(54) SEMICONDUCTOR DEVICE AND METHOD FOR MANUFACTURING THE SAME

(75) Inventors: Sang Hee LEE, Eumseong-gun (KR); Gab Hwan CHO, Icheon-si (KR)

Correspondence Address: WORKMAN NYDEGGER, 60 EAST SOUTH TEMPLE, 1000 EAGLE GATE TOWER, SALT LAKE CITY, UT, 84111, US

(73) Assignee: DONGBU HITEK CO., LTD., Seoul (KR)

(21) Appl. No.: 12/118,529

(22) Filed: May 9, 2008

(30) Foreign Application Priority Data
May 10, 2007 (KR) 10-2007-0045623

(51) Int. Cl. G02B 7/02; B29D 11/00

(52) U.S. Cl. 359/811; 216/26

(57) ABSTRACT

A semiconductor device and a method for manufacturing the same. The method includes setting a pattern region, forming a series of virtual mesh lines on the pattern region, forming a plurality of patterns in the pattern region, and substituting each of the patterns with either a red (R), green (G), or blue (B) patterns in accordance with a contact rule between the virtual mesh lines. Accordingly, it is possible to enhance the pattern uniformity between a main pattern region and a dummy pattern region, and thus to secure a uniform critical dimension (CD) of each pattern. Also, the patterning process for the color filter can be automatized to minimize the amount of data required to design a pattern. Also, the designing and manufacturing processes can be simplified, meaning that they can be more rapidly and precisely achieved.

This application claims the benefit of the Korean Patent Application No. 10-2007-0045623, filed on 10 May 2007, which is hereby incorporated by reference.

### BACKGROUND OF THE INVENTION

1. Field of the Invention

The present invention relates to a semiconductor device, and more particularly, to a semiconductor device and method of manufacturing a semiconductor using a specific mask design.

2. Discussion of the Related Art

Generally, a semiconductor devices have a multi-layered structure, wherein the layers are formed using a sputtering or a chemical vapor deposition method. The layers are then formed into a predetermined pattern in a subsequent photolithography process.

Unfortunately, however, problems may arise in the semiconductor device due to variations in the sizes and/or densities of the patterns. In order to correct such defects from occurring, a technique has been developed wherein a plurality of dummy patterns are formed together with main patterns.

When this technique is applied to a color filter, however, there is no dummy pattern in any are other than the main pattern area. Thus, there may be problems securing pattern uniformity. Due to this problem, the critical dimension (CD) of the patterns may not be uniform. Furthermore, the patterning process for the color filter must be manually performed. As a result, the amount of data required to design a pattern for a color filter is excessively large, so that it is impossible to rapidly and precisely achieve the design of a color filter.

### BRIEF SUMMARY OF THE INVENTION

Accordingly, the present invention is directed to a semiconductor device and a method for manufacturing the same that substantially obviates one or more problems of the related art.

An object of the present invention is to provide a semiconductor device and a method for manufacturing a semiconductor device with a desired pattern uniformity.

Another object of the present invention is to provide a semiconductor device and a method for manufacturing a semiconductor device with a uniform critical dimension (CD) in each pattern, in order to obtain a higher pattern density.

Another object of the present invention is to provide a semiconductor device and a method for manufacturing a semiconductor device that is manufactured using an automated patterning process for manufacturing a color filter.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, one aspect of the present invention is a method for manufacturing a semiconductor device comprising setting a pattern region, forming a series of virtual mesh lines on the pattern region, forming a plurality of patterns in the pattern region, and substituting each of the patterns with a corresponding red (R), green (G), or blue (B) patterns in accordance with a contact rule between the virtual mesh lines.

A second aspect of the present invention is a method for manufacturing a semiconductor device comprising forming a plurality of main patterns of a color filter on a substrate and forming a plurality of dummy patterns of the color filter to one side of the main patterns of the color filter.

Another aspect of the present invention is a semiconductor device comprising a plurality of main patterns of a color filter formed on a substrate and a plurality of dummy patterns of the color filter formed to one side of the main patterns of the color filter.

### BRIEF DESCRIPTION OF THE DRAWINGS

The accompanying drawings, which are included to provide a further understanding of the invention and are incorporated in and constitute a part of this application, illustrate embodiment(s) of the invention. The drawings, along with the description and claims serve to explain the invention. In the drawings:

FIG. 1 illustrates a semiconductor device according to an exemplary embodiment of the present invention;

FIGS. 2A and 2B are cross-sectional views of the semiconductor device according to the illustrated embodiment of the present invention; and

FIGS. 3A to 3D illustrate a method of designing a mask according to the present invention.

### DETAILED DESCRIPTION OF THE INVENTION

Reference will now be made in detail to the preferred embodiments of the present invention, examples of which are illustrated in the accompanying drawings

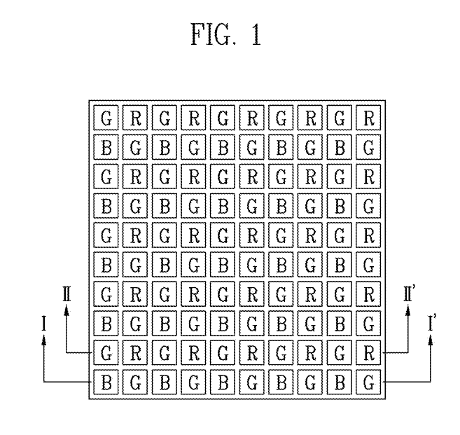

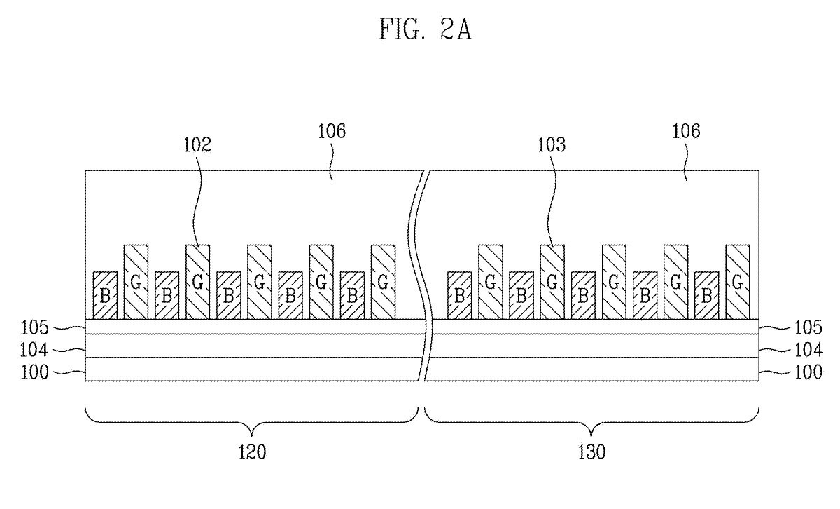

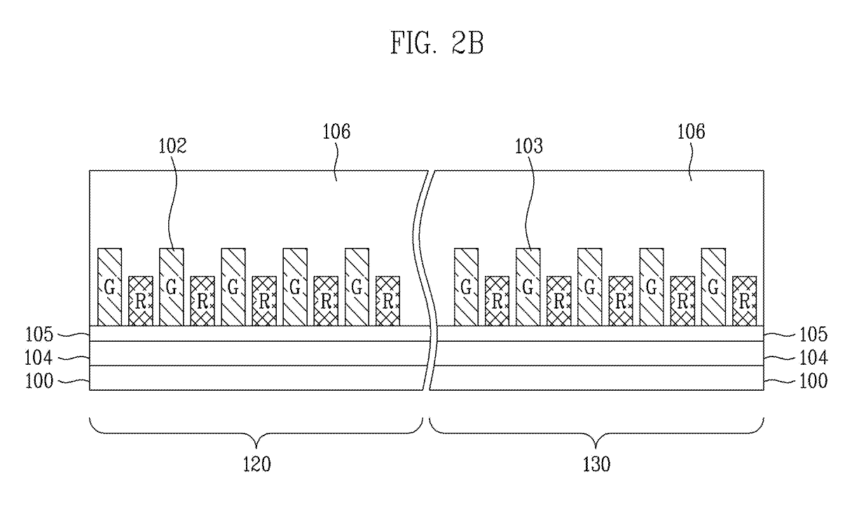

FIG. 1 is a plan view of a semiconductor device according to an exemplary embodiment of the present invention. FIGS. 2A and 2B are cross-sectional views of the semiconductor device according to the illustrated embodiment of the present invention along the cross sectional lines I-I′ and II-II′, respectively.

As shown in FIGS. 2A and 2B, the semiconductor device includes a dummy pattern region 120 and a main pattern region 130 for forming a color filter. In FIG. 2A, the dummy pattern region 120 is shown through a cross-sectional view of the semiconductor device taken along the line I-I′ in FIG. 1. In FIG. 2B, the dummy pattern region 120 is shown through a cross-sectional view of the semiconductor device taken along the line II-II′ in FIG. 1.

Referring to FIGS. 1 to 2B, the semiconductor device includes a metal layer 104, an interlayer insulating film 105, dummy patterns 102, main patterns 103, a planarizing layer 106, and micro lenses (not shown).

More specifically, a metal layer 104 is formed over a semiconductor substrate 100. The metal layer 104 may be a top metal layer. Of course, the metal layer 104 is not limited to the top metal layer, and may be any layer used to form a semiconductor.

An interlayer insulating film 105 is formed over the metal layer 104. The interlayer insulating film 105 may have a single layer structure or a multi-layer structure.

In the main pattern region 130, the main patterns 103 are formed on the interlayer insulating film 105, for a color filter. In the dummy pattern region 120, the dummy patterns 102 are formed on the interlayer insulating film 105, for the color filter. Referring to the drawings, it can be seen that the dummy patterns 102 are formed in a region where the main patterns 103 are not arranged, namely, the dummy pattern region 120 arranged to the side of the main pattern region 130. The main patterns 103 shown in FIGS. 2A and 2B may have a pattern arrangement identical to or different from the pattern arrangement of the dummy patterns 102. For example, as shown in FIG. 2A, the main patterns 103 may have a pattern arrangement, in which G (Green) and B (Blue) patterns are alternately arranged, with a similar configuration being used to form the dummy patterns 102 arranged on the left side of the main patterns 103. Also, as shown in FIG. 2B, the main patterns 103 may have a pattern arrangement, in which G(Green) and R(Red) patterns are alternately arranged, with similarly configured dummy patterns 102 arranged on the left side of the main patterns 103.

The planarizing layer 106 is formed over the interlayer insulating film 105, main patterns 103, and dummy patterns 102 of the color filter, in order to provide a planarized or level surface capable of securing a desired flatness for the formation of a lens layer, and for the adjustment of a focal length. The micro lenses are formed on the planarizing layer 106.

Hereinafter, embodiments of a method for manufacturing the above-described semiconductor device in accordance with the present invention will be described.

In a semiconductor device manufacturing method according to an exemplary embodiment of the present invention, the metal layer 104 is first formed over the semiconductor substrate 100, so as to cover both the main pattern region 130 and the dummy pattern region 120 of the color filter. Then, the interlayer insulating film 105 is formed over the metal layer 104. The dummy patterns 102 and main patterns 103 of the color filter are formed on the interlayer insulating film 105. In this case, the dummy patterns 102 may be formed in a region where the main patterns 103 are not arranged, namely, the dummy pattern region 120 arranged on one side of the main pattern region 130.

The formation of the dummy patterns 102 and main patterns 103 may be achieved by coating a dyeable resist material over the interlayer insulating film 105, and patterning the coating of dyeable resist material, in order to form R, G, and B color filter patterns, each of which is capable of filtering light at a different wavelength range.

Subsequently, the planarizing layer 106 is formed over the dummy patterns 102 and main patterns 103 of the color filter. The micro lenses (not shown) are then formed on the planarizing layer 106.

As apparent from the above description, in the semiconductor device and manufacturing method thereof according to the present invention, the dummy patterns 102 of the color filter are formed in a region separate from the main patterns 103 of the color filter. Accordingly, it is possible to achieve an enhancement in the pattern uniformity between the main pattern region 130 and the dummy pattern region 120. By increasing the desired pattern uniformity, the uniformity of the critical dimensions (CD) of the pattern may also be improved.

The above-described main patterns 103 and dummy patterns 102 of the color filter may be formed using a mask design formed using a mask designing method described more fully below.

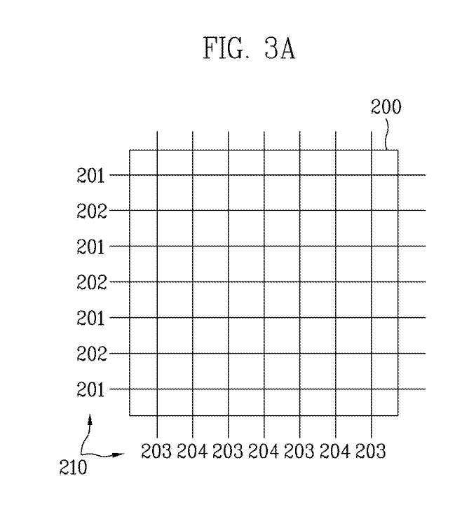

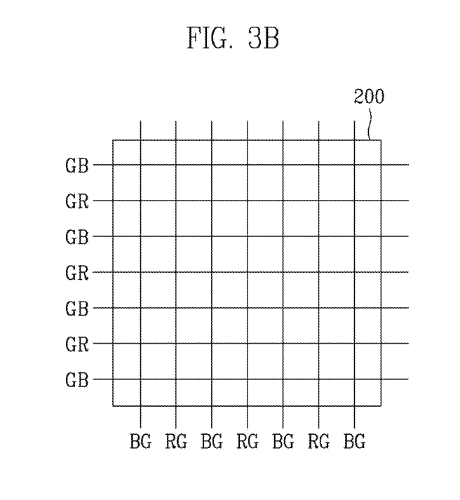

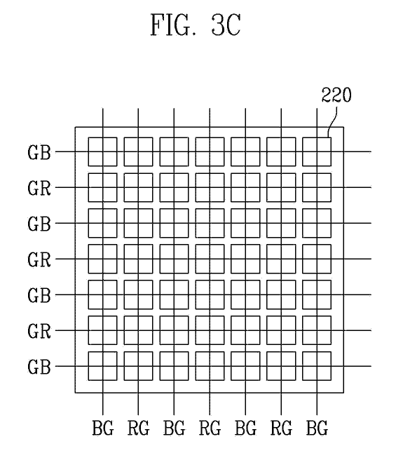

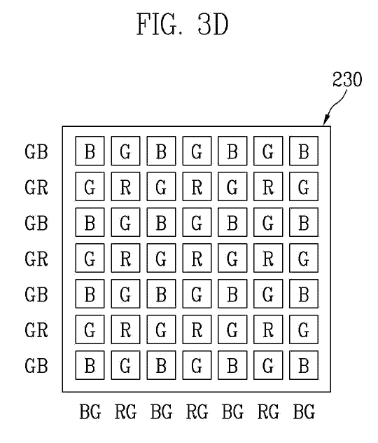

Hereinafter, a method of manufacturing a semiconductor device using a mask designing method of the present invention will be described with reference to FIGS. 3A-3D.

Thus, FIGS. 3A-3D illustrate the mask designing method according to the present invention.

First, a region 200, where patterns 102 or 103 will be formed (hereinafter, referred to as a “pattern region”), is set, as shown in FIG. 3A. The pattern region 200 may comprise a main chip or a main frame. Although the pattern region 200 is illustrated as having a square shape, it may have various shapes, and is not limited to a square shape.

Next, as shown in FIG. 3A, a series of virtual mesh lines 210 are formed on the pattern region 200. The virtual mesh lines 210 are formed by forming a series of first lines 201 and second lines 202 in the pattern region 200, which are formed so as to extend in a horizontal direction. The first lines 201 and second lines 202 alternate so as to form the horizontal lines in the virtual mesh lines 210. Then, a series of third lines 203 and fourth lines 204 are alternately formed in the pattern region 200. The third lines 203 and fourth lines 204 extend in a vertical direction so as to form the vertical lines in the mesh lines 210.

In this case, the first, second, third, and fourth lines 201-204 assigned to predetermined color lines, as shown in FIG. 3B.

For example, each first line 201 may designated as a green-blue (GB) line, each second line 202 may be designated as a green-red (GR) line, each third line 203 may be designated as a blue-green (BG) line, and each fourth line 204 may be designated as a red-green (RG) line. Of course, the present invention is not limited to this particular configuration, and the particular configuration used may vary. Here, the GB line represents a line on which alternating green (G) and blue (B) patterns will be arranged. The GR line represents a line, on which green (G) and red (R) patterns will be alternately arranged. The BG line represents a line on which blue (B) and green (G) patterns will be alternately arranged, and the RG line represents a line on which red (R) and green (G) patterns will be alternately arranged.

Thereafter, a plurality of patterns 220 are formed in the pattern region 200, as shown in FIG. 3C. In this example, the pattern region 200 has a square shape, and a plurality of square patterns 220 are formed in the pattern region 200.

In this case, the patterns 220 may comprise the main patterns 103 of the color filter. Of course, the patterns 220 are not limited to the main patterns 103 of the color filter, and the patterns 220 may also be the dummy patterns 102 of the color filter.

In this example, the intersections of the first and second lines 201 and 202 with the third and fourth lines 203 and 204 are set such that each intersection between the lines 201-204 corresponds with a single pattern 220, as shown in FIG. 3C.

Thereafter, each pattern 220 is designated as a red (R), green (G), pr blue (B) pattern, as shown in FIG. 3D, using a “contact rule” wherein the patterns 220 are assigned based on the intersection of the designations of the virtual mesh lines 210 at each pattern 220.

Depending on the intersection between the virtual mesh lines 210 at each pattern 220, a pattern 220 is assigned at each intersection. In the example shown in FIG. 3D, every pattern 220 positioned at the intersections between first lines 201 and third lines 203 is set as a blue (B) pattern. Each pattern 220 positioned at intersections between each second line 202 and fourth line 204 is set to a red (R) pattern. Every pattern 220 positioned at an intersection between a second line 202 and third line 203 is set to a green (G) pattern. Each pattern 220 positioned at every intersection between a first line 201 and fourth line 204 is also set to a green (G) pattern. As may be understood by one of ordinary skill in the art however, the assignments of the virtual mesh lines 210 and patterns 220 is not limited to the above-described example and may be varied without departing from the scope of the present invention.

More specifically, in this example, each pattern 220 positioned at and intersection between a GB line and BG line is set to a blue (B) pattern. Each pattern 220 positioned at the intersection between a GR line and RG line is set to a red (R) pattern. Each pattern 220 positioned at an intersection between a GR line and BG line is set to a green (G) pattern, and each pattern 220 positioned at an intersection between a GB line and RG line is also set to a green (G) pattern.

Using this mask designing method, it is possible to automate the patterning process for the color filter by forming the patterns 220 of the color filter as shown in FIG. 3C, and then substituting each pattern 220 with a corresponding R, G, or B pattern, based on the designations of the virtual mesh lines 210m as shown in FIG. 3D. Accordingly, it is possible to minimize the amount of data required to design a pattern, while rapidly and precisely achieving the design of the color filter.

As may be understood by one of ordinary skill in the art, the order that the processes of the mask designing method are performed may vary, and those described in conjunction with the illustrated embodiment of the present invention are intended only for illustrative purposes. Various combinations of the above-described processes may fall under the scope of the appended claims.

It will be apparent to those skilled in the art that various modifications and variations can be made in the present invention without departing from the spirit or scope of the inventions. Thus, it is intended that the present invention covers any modifications and variations of this invention that come within the scope of the appended claims and their equivalents.

As apparent from the above description, in the semiconductor device and method of manufacturing a semiconductor device of the present invention, the dummy patterns of a color filter are formed in a separate region from the main patterns of the color filter. Accordingly, it is possible to enhance the pattern uniformity between the main pattern region and the dummy pattern region. Thus, it is possible to secure more uniform critical dimensions (CD) in each pattern. Also, the patterning process for the color filter can be automatized to minimize the amount of data required to design a pattern. Also, the designing and manufacturing processes can be simplified, so that they can be rapidly and precisely achieved.

What is claimed is:

1. A method for manufacturing a semiconductor device, comprising:
setting a pattern region;
forming a plurality of virtual mesh lines on the pattern region;
forming a plurality of patterns in the pattern region; and
substituting each pattern in the pattern region with a corresponding red (R), green (G), or blue (B) pattern in accordance with a contact rule between the virtual mesh lines.

2. The method according to claim 1, wherein forming the virtual mesh lines on the pattern region comprises:
forming a series of horizontal virtual mesh lines comprised of a series of alternating first and second lines which extend in a horizontal direction; and
forming a series of vertical virtual mesh lines comprised of a series of alternating third and fourth lines which extend in a vertical direction.

3. The method according to claim 2, wherein each first line comprises a green-blue (GB) line, each second line comprises a green-red (GR) line, each third line comprises a blue-green (BG) line, and each fourth line comprises a red-green (RG) line.

4. The method according to claim 3, wherein the first and second lines intersect the third and fourth lines, wherein the intersections are positioned within the patterns.

5. The method according to claim 4, wherein substituting of each pattern in accordance with the contact rule comprises:
setting each pattern positioned at an intersection between a first line and third line to a blue (B) pattern;
setting each pattern positioned at an intersection between a second line and fourth line to a red (R) pattern;
setting each pattern positioned at an intersection between a second line and third line to a green (G) pattern; and
setting each pattern positioned at an intersection between a first line and fourth line.

6. The method according to claim 5, wherein the patterns comprise the main patterns of a color filter.

7. The method according to claim 5, wherein the patterns comprise the dummy patterns of a color filter.

8. A method for manufacturing a semiconductor device, comprising:
forming a plurality of main patterns of a color filter on a substrate; and
forming a plurality of dummy patterns of the color filter to the side of the main patterns of the color filter.

9. The method according to claim 8, further comprising:
forming a metal layer over the substrate; and
forming an interlayer insulating film over the metal layer,
wherein the main and dummy patterns of the color filter are formed on the interlayer insulating film.

10. The method according to claim 9, further comprising:
forming a planarizing layer over the interlayer insulating film, main pattern, and dummy pattern of the color filter; and
forming micro lenses on the planarizing layer.

11. A semiconductor device comprising:
a plurality of main patterns of a color filter formed on a substrate; and
a plurality of dummy patterns of the color filter formed to the side of the main patterns of the color filter.

12. The semiconductor device according to claim 11, further comprising:
a metal layer formed over the substrate; and
an interlayer insulating film formed over the metal layer,
wherein the plurality of main and dummy patterns of the color filter are formed on the interlayer insulating film.

13. The semiconductor device according to claim 12, further comprising:
a planarizing layer formed over the interlayer insulating film, main patterns, and dummy patterns of the color filter; and
micro lenses formed on the planarizing layer.

14. A semiconductor device comprising:
a plurality of main patterns of a color filter formed on a substrate; and
a plurality of dummy patterns of the color filter formed to the side of the main patterns of the color filter;
wherein the plurality of main patterns and dummy patterns of the color filter are formed using the method of claim 1.

15. The semiconductor device according to claim 14, further comprising:
a metal layer formed over the substrate; and
an interlayer insulating film formed over the metal layer,
wherein the plurality of main and dummy patterns of the color filter are formed on the interlayer insulating film.

16. The semiconductor device according to claim 15, further comprising:
a planarizing layer formed over the interlayer insulating film, main patterns, and dummy patterns of the color filter; and
micro lenses formed on the planarizing layer.
